(19) United States
(12) Patent Application Publication
(10) Pub. No.: US 2007/0185974 A1
(43) Pub. Date: Aug. 9, 2007

(54) Communication Terminal Device and Communication Method

(75) Inventor: Shinji KAWASAKI, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA KIKAI KABUSHIKI KAISHA, Kyoto-shi (JP)

(21) Appl. No.: 11/670,346

(22) Filed: Feb. 1, 2007

(30) Foreign Application Priority Data
Feb. 8, 2006 (JP) 2006-030956

(51) Int. Cl. G06F 15/16; G06F 7/00; G06F 17/00

(52) U.S. Cl. 709/217; 709/206; 707/100; 707/104.1

(57) ABSTRACT

A communication terminal device registers destination information to be a transmission destination when transmitting transmission data, and registers a folder by associating with the registered destination information in a manner that the folder can be designated based on the registered destination information. The communication terminal device accepts a designation of destination information to be a transmission destination of transmission data from the registered destination information, and specifies a folder corresponding to the accepted destination information. The communication terminal device acquires data information of the specified folder, and indicates the acquired data information. The communication terminal device uses the indicated data information to accept a designation of transmission data, and transmits the accepted transmission data to a transmission destination.

### RELATED APPLICATIONS

This application claims priority under 35 USC 119 in Japanese application no. 2006-030956, filed on Feb. 8, 2006, which application is hereby incorporated by reference in its entirety.

### BACKGROUND OF THE INVENTION

1. Field of the Invention

The present invention relates to a communication terminal device and a communication method, and in particular relates to a communication terminal device and a communication method capable of selecting a destination from previously registered destinations, and transmitting data attached to an e-mail.

2. Description of the Related Art

Conventional communication terminal devices such as a facsimile machine and a Multi Function Peripheral (MFP) may be connected to a network, and may forward data to information equipment such as a Personal Computer (PC) via the network. For example, a document file created by the PC is stored in a shared folder, and a communication terminal device acquires the document file via the network and transmits the acquired document file to a destination. The communication terminal device uses a scanner function of the facsimile machine to scan image data from an original document, and forwards the scanned image data to the shared folder via the network.

A conventional file manager registers a folder name by associating with a speed-dial key of the facsimile machine. According to an operation performed by the speed-dial key, the file manager transmits image data, which has been scanned by a scanner, and the corresponding folder name to the PC. The PC stores the image data in a folder having the received folder name. Accordingly, the forwarded file can be stored in a previously designated folder, enabling the file to be easily found later.

When transmitting data previously stored in the shared folder or the like from the facsimile machine or the like, it is necessary to find and specify a folder that is accessible from the facsimile machine and to designate transmission data in the specified folder. Therefore, when a systematic folder structure is not formed or when a file is stored in a folder having a deep hierarchical file system, extreme time and effort is required for a user to find a target file. Thus, usability is low.

### SUMMARY OF THE INVENTION

In order to overcome the problems described above, the present invention provides a communication terminal device and a communication method that reduces efforts and improves operability when designating data to be transmitted to a registered destination.

According to a first aspect of the present invention, a communication terminal device includes a destination information registering unit, a folder registering unit, a destination accepting unit, a folder specifying unit, a data information acquiring unit, an indicating unit, a transmission data accepting unit, and a transmission unit. The destination information registering unit registers destination information to be a transmission destination when transmitting transmission data. The folder registering unit registers a folder by associating the folder with the destination information registered in the destination information registering unit in a manner that the folder can be specified based on such destination information. The destination accepting unit accepts a designation of the destination information to be the transmission destination of the transmission data from the destination information registered in the destination information registering unit. The folder specifying unit specifies a folder corresponding to the destination information accepted by the destination accepting unit. The data information acquiring unit acquires data information of the folder specified by the folder specifying unit. The indicating unit indicates the data information acquired by the data information acquiring unit. The transmission data accepting unit accepts a designation of the transmission data by using the data information indicated by the indicating unit. The transmission unit transmits the transmission data accepted by the transmission data accepting unit to the transmission destination.

The transmission data can be stored in a storage device that can be referenced by the communication terminal device. The storage device may be provided in the communication terminal device itself, or may be a remote storage device connected to the communication terminal device via a network. When the transmission data is stored in the remote storage device, the folder and the data may be referenced by using the Server Message Block (SMB) protocol or the like, for example. The destination information may include a destination name, a telephone number for facsimile, and a mail address or the like.

The folder registering unit can register a folder under a folder name including a portion of information included in the destination information. The user is not necessarily required to memorize the folder name. For example, the folder registering unit may previously designate to use the destination information (for example, the first five letters of a destination name) as the folder name, and register the folder under such a folder name. Accordingly, the user can recognize that a folder is the folder that has been associated with the registered destination information according to the designation. Alternatively, a folder name of the folder associated with the destination information, a path of the folder, or information of a link or the like may be registered by being associated with each destination information. Any name may be assigned as the folder name. Alternatively, a name including a portion of the destination name included in the destination information, a facsimile number or a mail address, etc., or any combination of these may be used as the folder name.

According to a second aspect of the present invention, the folder is registered by being associated with the destination information, and the folder stored in a data storage location can be referenced just by designating a destination at transmission. Therefore, when designating a transmission file, time and effort required for finding a folder can be saved, and operability improves.

In the above-described communication terminal device, the destination information registering unit includes additional information into the destination information. The folder registering unit registers the folder by associating the folder with the additional information of the destination information in a manner that the folder can be specified based on the additional information. The folder specifying unit acquires the additional information of the destination information accepted by the destination accepting unit from the destination information registering unit, and specifies the folder based on the additional information. The additional information may include any keyword or path information.

In the above-described communication terminal device, when newly registering the destination information in the destination information registering unit, the folder registering unit automatically creates a new folder in the data storage unit of the communication terminal device itself or the data storage unit of the remote storage device, which can be referenced by the communication terminal device via the network, by associating the folder with the destination information. Then, the new folder can be registered in the folder registering unit by being associated with the newly registered destination information.

In the communication terminal device, when the folder registering unit automatically creates the new folder, the folder registering unit generates a folder name based on the destination information, and assigns the generated folder name to the new folder. According to this constitution, since the destination information may be assigned as a portion of the folder name when registering the destination information, the folder name is easily understandable to a user when storing transmission data and usability is high.

In the above-described communication terminal device, the folder registering unit determines a presence or an absence of a folder, which can be specified based on the newly registered destination information, in the data storage unit. In case of a presence of the folder that can be specified, without creating the new folder, the folder registering unit can register the existing folder by associating with the destination information.

In the above-described communication terminal device, the destination information registering unit can register a plurality of the destination information as a group. The folder registering unit can register the folder by associating the folder with the group in a manner that the folder can be specified based on the group. According to this constitution, a plurality of destinations to which broadcast transmission is frequently carried out may be previously registered as a group, and a folder may be registered by being associated with such a group.

In the above-described communication terminal device, when the destination accepting unit accepts a plurality of the destination information as transmission destinations, in case there are a plurality of folders corresponding to the plurality of the destination information, the data information acquiring unit acquires the data information of the plurality of the folders. The indicating unit indicates each of the plurality of the data information acquired by the data information acquiring unit.

An indicating method of the indicating unit is not limited in particular. For example, the indicating unit may notify a user that there are a plurality of folders associated with a plurality of transmission destinations designated for broadcast transmission to enable the user to select from which folder to browse. Alternatively, the indicating unit may indicate the data information of the associated folders in an order in which broadcasting has been designated. Alternatively, the indicating unit may indicate the data information of the associated folders in a prescribed order of the plurality of the transmission destinations, for example, an order in which the transmission destinations have been designated, an order of destination names, an order of registered key numbers, an order of destination numbers, an order of keywords, or an order of the path names or the like.

The above-described communication terminal device also includes a deleting unit. After the transmission unit transmits the transmission data, the deleting unit deletes the transmitted transmission data from the folder. The communication terminal device may also include a moving unit. After the transmission unit transmits the transmission data, the moving unit moves the transmitted transmission data from the folder to another folder.

Further, combinations of the above-described constituent elements and conversions of the expression of the invention between a method, a device, a system, a recording medium, a computer program or the like are also effective as embodiments of the present invention.

The present invention provides a communication terminal device and a communication method which reduce efforts and improve operability when designation data to be transmitted to a registered destination.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram illustrating a network configuration of a communication terminal device according to an embodiment of the present invention.

FIG. 2 is a functional block diagram illustrating a configuration of a communication terminal device according to an embodiment of the present invention.

FIGS. 3A-3C illustrate examples of a structure of one-touch dial destination information registered in a transmission destination information registering unit of the communication terminal device of FIG. 2.

FIG. 4 illustrates an example of a structure of group registration information registered in the transmission destination information registering unit of the communication terminal device of FIG. 2.

FIG. 5 illustrates an example of a structure of group folder information registered in the transmission destination information registering unit of the communication terminal device of FIG. 2.

FIG. 6 is a flowchart illustrating an example of an operation carried out by the communication terminal device of FIG. 2 when registering a destination.

FIG. 7 is a flowchart illustrating an example of an operation carried out by the communication terminal device of FIG. 2 when transmitting data.

### DETAILED DESCRIPTION OF THE INVENTION

Embodiments of the present invention will be described with reference to the drawings. In the drawings, like reference numerals are assigned to like constituent elements, and duplicative descriptions are omitted as appropriate.

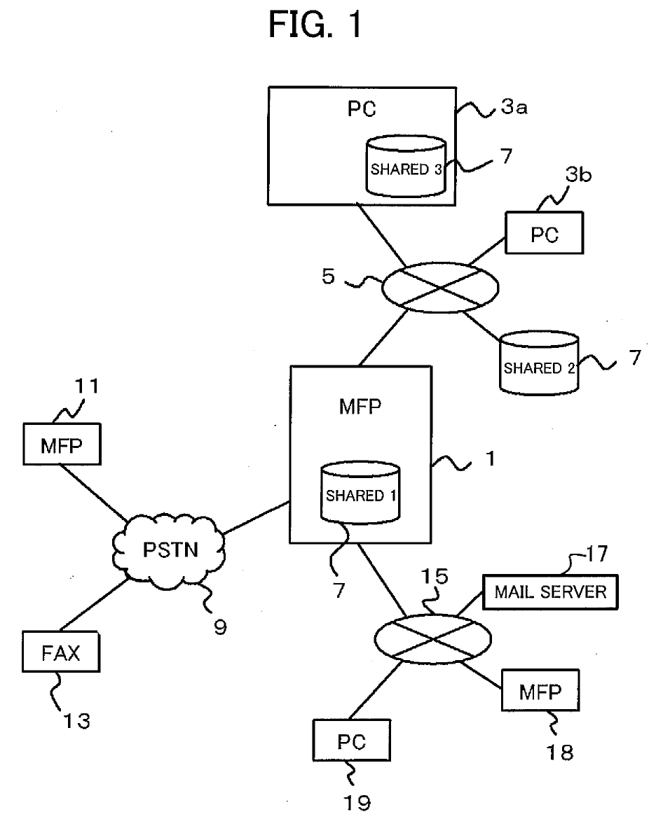

FIG. 1 is a block diagram illustrating a network configuration of a communication terminal device according to one embodiment of the present invention. For example, the communication terminal device is a Multi Function Peripheral (MFP) 1. Alternatively, the communication terminal device may be a network facsimile machine, or an Internet facsimile machine. The MFP 1 includes a shared storage device 7 (shared 1). The communication terminal device according to this embodiment includes one-touch dial keys (not illustrated) and a ten-key numeric pad (not illustrated) that are arranged on an operation panel (not illustrated). The ten-key numeric pad is operated when designating speed-dialing. When a user operates the keys and designates a destination, a folder corresponding to the designated destination automatically opens. Alternatively, a plurality of destinations can be registered as a group. Then, when the group is designated as a destination, a folder corresponding to the designated group automatically opens. The user selects a file to be attached from files stored in the folder, which is stored in the shared storage device 7 and corresponds to the destination. Then, the communication terminal device transmits a facsimile or e-mail to the destination designated by a one-touch dial key, a speed-dial number or a group.

The MFP 1 is connected to personal computers (a PC 3a and a PC 3b, and in the following, unless the PC 3a and the PC 3b are explicitly distinguished, the PC 3a and the PC 3b are correctively referred to as “PC 3”) and a shared storage device 7 (shared 2) via a network 5. The PC 3a includes a shared storage device 7 (shared 3). The shared storage devices 7 (the shared 1, the shared 2, and the shared 3) can access one another via the network 5. Each device, for example, can refer to folders stored in the shared storage devices 7 by the SMB protocol or the like.

The MFP 1 is also connected to another MFP 11 and a facsimile machine (FAX) 13 via a Public Switched Telephone Network (PSTN) 9. The MFP 1 can carry out Group 3 (G3) or Group 4(G4) facsimile transmission to the MFP 11 and the FAX 13. The MFP 1 is connected to a mail server 17 via a network 15. The MFP 1 can transmit e-mail to an MFP 18, a PC 19 or other communication terminals (not illustrated).

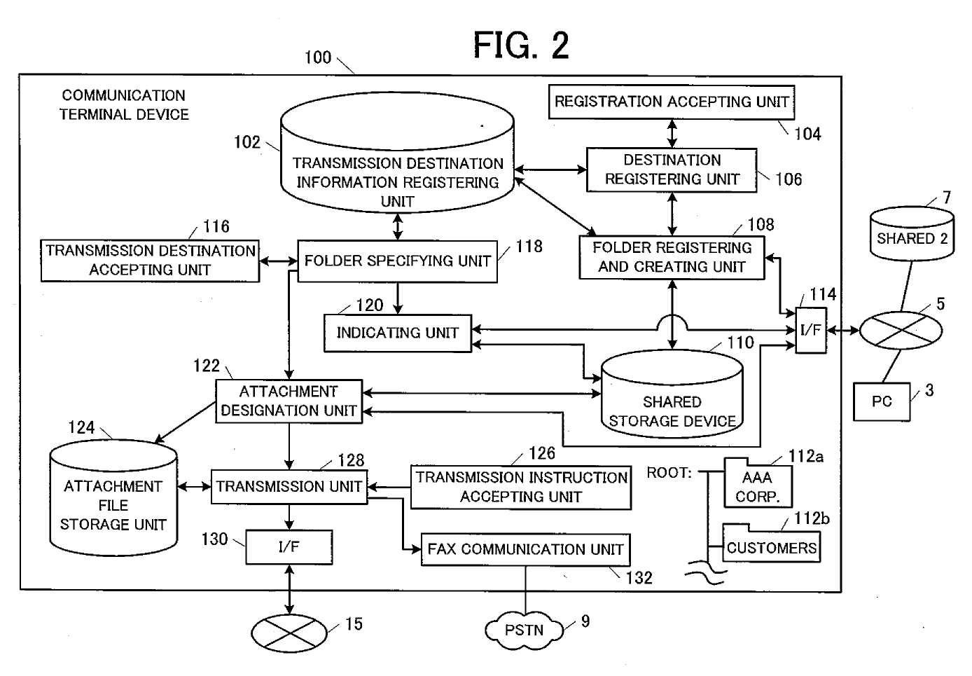

FIG. 2 is a functional block diagram illustrating a configuration of a communication terminal device 100. Communication terminal device 100 includes the following elements:

(i) a destination information registering unit (transmission destination information registering unit 102) that registers destination information to be a transmission destination when transmitting data;
(ii) a folder registering unit (folder registering and creating unit 108) that registers a folder by associating the folder with the destination information registered in the destination information registering unit (transmission destination information registering unit 102) in a manner that the folder can be specified based on such destination information;
(iii) a destination accepting unit (transmission destination accepting unit 116) that accepts a designation of destination information to be the transmission destination of the transmission data from the destination information registered in the destination information registering unit (transmission destination information registering unit 102);
(iv) a folder specifying unit 118 that specifies a folder corresponding to the destination information accepted by the destination accepting unit (transmission destination accepting unit 116);
(v) a data information acquiring unit (indicating unit 120) that acquires data information of the folder specified by the folder specifying unit 118;
(vi) the indicating unit 120 that indicates the data information acquired by the data information acquiring unit (indicating unit 120);
(vii) a transmission data accepting unit (attachment designation unit 122) that accepts a designation of data using the data information indicated by the indicating unit 120; and
(viii) a transmission unit (transmission unit 128, interface unit 130, and facsimile communication unit 132) that transmits the transmission data accepted by the transmission data accepting unit (attachment designation unit 122) to the transmission destination.

In FIG. 2, elements that do not relate to the subject matter of the present invention are not illustrated. For example, a scanner unit, an image processing unit, and a printer unit or the like that are generally provided in a facsimile machine are not illustrated.

Each constituent element of the communication terminal device 100 is realized by any combination of hardware and software, primarily by a Central Processing Unit (CPU) of any computer, a memory, a program which is loaded in the memory and realizes the constituent elements illustrated in FIG. 2, a storage unit such as a hard disk that stores the program, and/or a network interface card. It is understood by those skilled in the art that various changes and modifications can be made to methods and devices for realizing each of the constituent elements. Each drawing described hereinafter illustrates blocks representing units of function, instead of units of hardware.

A control program for controlling the operation of the communication terminal device 100 controls a computer including the destination information registering unit (transmission destination information registering unit 102), the folder registering unit (folder registering and creating unit 108), the destination accepting unit (transmission destination accepting unit 116), the folder specifying unit (folder specifying unit 118), the data information acquiring unit (indicating unit 120), the indicating unit (120), the transmission data accepting unit (attachment designation unit 122), and the transmission unit (transmission unit 128, interface unit 130, and facsimile communication unit 132).

The communication terminal device 100 includes a storage unit (not illustrated), which stores the control program and includes a work area for executing the program, and a processor (not illustrated), which executes the control program.

As illustrated in FIG. 2, the communication terminal device 100 includes the transmission destination information registering unit 102, a registration accepting unit 104, a destination registering unit 106, the folder registering and creating unit 108, a shared storage device 110, an interface unit (I/F) 114, the transmission destination accepting unit 116, the folder specifying unit 118, the indicating unit 120, the attachment designation unit 122, an attachment file storage unit 124, a transmission instruction accepting unit 126, a transmission unit 128, an interface unit (I/F) 130, and a facsimile communication unit 132.

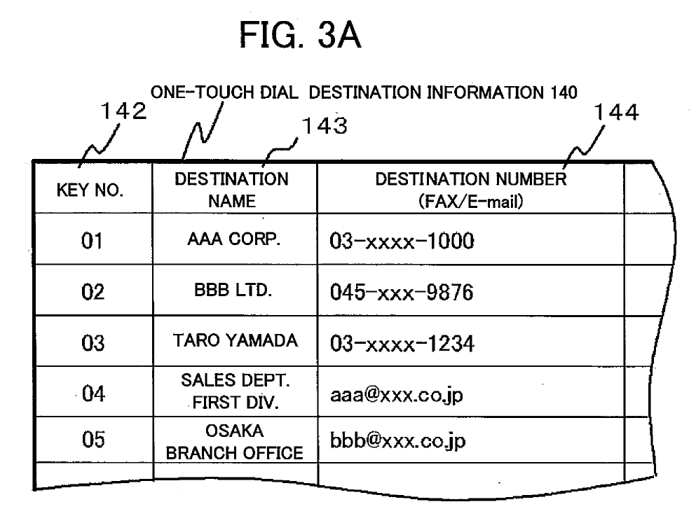

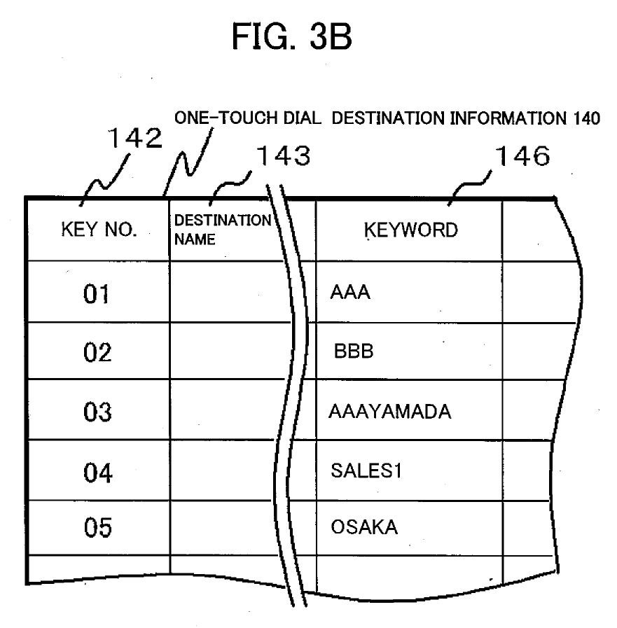

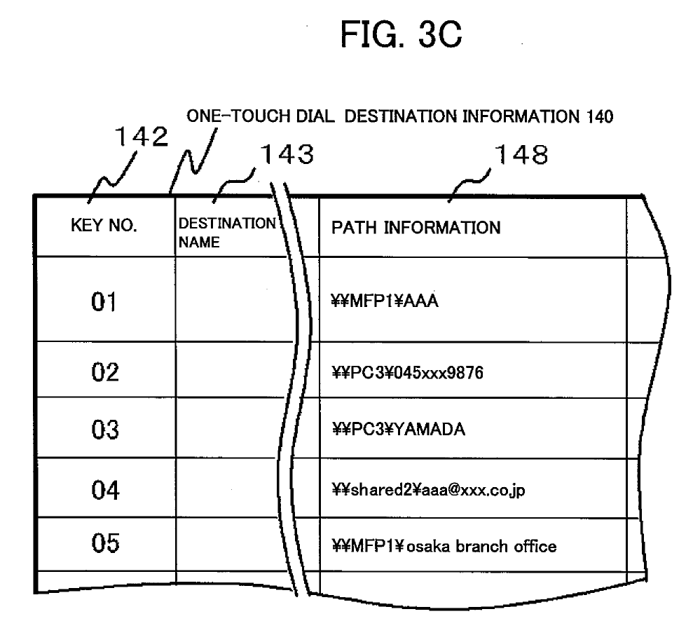

The transmission destination information registering unit 102 includes one-touch dial destination information 140 illustrated in FIGS. 3A-3C, and speed-dial destination information (not illustrated). The communication terminal device 100 can register any destination to each of a prescribed number of one-touch dial keys and a prescribed number of speed-dial keys. By pressing a one-touch dial key, facsimile transmission or e-mail transmission is carried out to the registered destination. By pressing a speed-dial key to designate a registered number, facsimile transmission or e-mail transmission is carried out to the registered destination.

As illustrated in FIG. 3A, the one-touch dial destination information 140 includes registrations of a destination name 143 and a destination number 144, such as a telephone number for facsimile or an e-mail address (FAX/e-mail), for each one-touch dial key number 142. The speed-dial destination information has the same structure as the one-touch dial destination information 140. The speed-dial destination information includes registrations of a destination name and a destination number for each speed-dial number. In the following, only the one-touch dial destination information 140 is described, and the same description applies to the speed-dial number.

Referring to FIG. 2 again, the registration accepting unit 104 accepts an entry of information when registering a destination with a one-touch dial key. The user can register a destination with a one-touch dial key by using an operation panel (not illustrated) of the communication terminal device 100, or using a browser from the PC 3 connected to the communication terminal device 100 via the network 5. In a first example, the registration accepting unit 104 accepts a destination name and a destination number for each one-touch dial key.

The destination registering unit 106 registers information necessary for the registration accepted by the registration accepting unit 104, e.g. a destination name and a destination number, with the one-touch dial destination information 140 of the transmission destination information registering unit 102. The folder registering and creating unit 108 registers a folder by associating the folder with the destination registered with the one-touch dial key in a manner that the folder can be specified based on such a registered destination. In the first example, the folder registering and creating unit 108 associates a folder having the destination name 143 as a folder name with each destination registered in the one-touch dial destination information 140 stored in the transmission destination information registering unit 102. Further, the folder name may include at least a portion, e.g. first six letters, of the destination name 143. When the same folder name generates, a serial number may be added automatically.

The folder is stored in a prescribed data storage unit, e.g. a prescribed directory of the shared storage device 110. The prescribed data storage unit may be a device other than the shared storage device 110, and may be the shared storage device 7 on the network 5 or the shared storage device 7 of the PC 3. For example, a destination, which is registered with a one-touch dial key “01” and has a destination name 143 “AAA CORP.”, is associated with an “AAA CORP.” folder 112a, which has a folder name “AAA CORP.” and is located immediately under a root directory of the MFP 1 illustrated in FIG. 1.

The folder registering and creating unit 108 determines a presence or an absence of a folder having the destination name 143 of the destination as the folder name in a prescribed directory of a prescribed data storage unit. In case of an absence of such a folder, the folder registering and creating unit 108 automatically creates a folder with a folder name having at least a portion of the destination name 143. Further, other than including the destination name 143, the folder name may include at least a portion of the key number 142 or the destination number 144. Alternatively, the folder name may be a combination of the destination name 143, the key number 42, and/or the destination number 144. When the same folder name generates, a serial number may be automatically added to the folder name.

In a second example, the registration accepting unit 104 may accept additional information in addition to the destination name and the destination number for each one-touch dial key. The destination registering unit 106 registers the accepted additional information with the one-touch dial destination information 140 stored in the transmission destination information registering unit 102. FIG. 3B illustrates an example in which keywords 146 are registered as the additional information in the one-touch dial destination information 140. For each key number 142, a keyword 146 is registered in addition to the destination name 142 and the destination number 144. FIG. 3C illustrates an example in which path information 148 is registered as additional information in the one-touch dial destination information 140.

In the example illustrated in FIG. 3B, the registration accepting unit 104 accepts a keyword for each destination registered with a one-touch dial key. The destination registering unit 106 registers the accepted keyword as the keyword 146 of the one-touch dial destination information 140. The folder registering and creating unit 108 associates a folder having the keyword 146 as the folder name to each destination registered in the one-touch dial destination information 140. The folder is stored in the prescribed directory of the prescribed data storage unit. The folder registering and creating unit 108 determines a presence or an absence of a folder having the keyword 146 as the folder name. In case of an absence of such a folder, the folder registering and creating unit 108 automatically creates a folder having the keyword 146 as the folder name.

In the example illustrated in FIG. 3C, the one-touch dial destination information 140 stores path information 148 by associating with each destination. Accordingly, a folder represented by the path information 148 may be associated with each destination. As one example of a method for registering the path information 148, the registration accepting unit 104 accepts an entry of path information for each destination registered with a one-touch dial key, and the destination registering unit 106 registers the entered path information as the path information 148 of the one-touch dial destination information 140.

The folder registering and creating unit 108 determines a presence or an absence of a folder designated by the path information 148. In case of an absence of such a folder, the folder registering and creating unit 108 automatically creates a folder designated by the path information 148. The path information 148 may include a device name, a folder name, and link information such as a Uniform Resource Locator (URL) or the like. Alternatively, as another example, the registration accepting unit 104 may activate a browser for the user to reference the data storage unit, and accept a designation of a device and a folder or an instruction for creating a new folder. The destination registering unit 106 may register the path information of the designated or created folder as the path information 148 of the one-touch dial destination information 140.

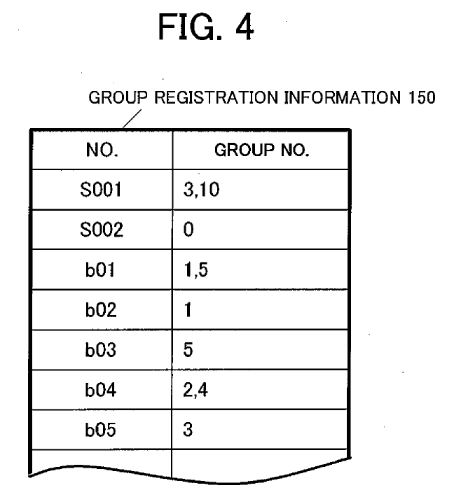

Destinations registered with the one-touch dial destination information 140 may be registered as groups, and a folder may be associated with each group. The registration accepting unit 104 accepts a group number for each destination registered with the one-touch dial destination information 140. A group number is selected from a prescribed number of groups (in one embodiment, 32 groups), and a plurality of group numbers may be registered. Moreover, by designating the group number as “0”, a destination may be registered correctively with all groups having group numbers from 1 to 32. The destination registering unit 106 registers group registration information accepted by the registration accepting unit 104 with group registration information 150 (FIG. 4) stored in the transmission destination information registering unit 102.

As illustrated in FIG. 4, the group registration information 150 stores group numbers registered for each one-touch dial key (b01 through b05) and each speed-dial number (“S001” and “S002”). In FIG. 4, a speed-dial number S001 is registered with group numbers 3 and 10. A speed-dial number S002 is registered with a group number 0, i.e. registered with all of groups with group numbers 1 through 32. A one-touch dial key b03 is registered with a group number 5. As another embodiment, instead of registering one-touch dial keys or the like as groups, any plural number of destinations may be registered with each group number.

The folder registering and creating unit 108 can register folders by associating the folders with a group in a manner that the folders can be specified based on the group. By using a group number for a folder name of such folders, the folders may be included in a prescribed directory of a prescribed storage unit. The folder registering and creating unit 108 determines a presence or an absence of a folder having a group number as a folder name in the prescribed directory of the prescribed data storage unit. In case of an absence of such a folder, the folder registering and creating unit 108 automatically creates a folder having the group number as the folder name.

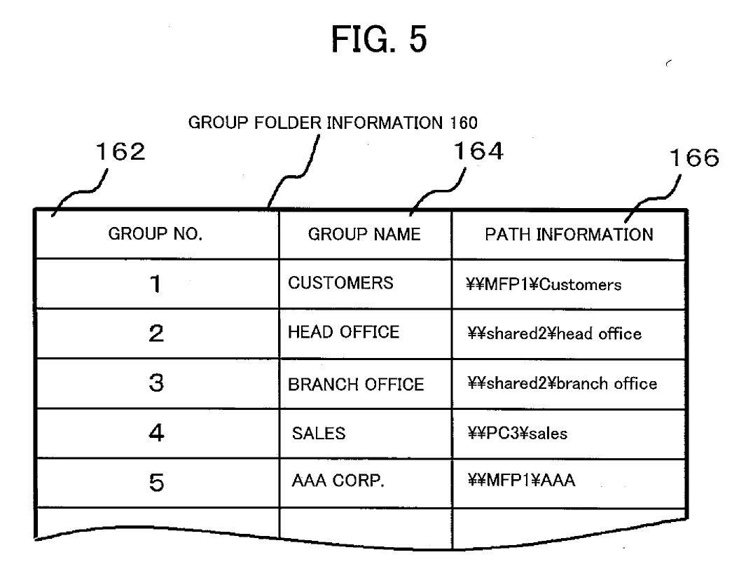

For each group, the registration accepting unit 104 can accept a keyword to be used as a folder name, and/or path information of the folder. The destination registering unit 106 registers the keyword and/or the path information accepted by the registration accepting unit 104 with group folder information 160 (FIG. 5) stored in the transmission destination information registering unit 102. In the example illustrated in FIG. 5, for each group number 162, the group folder information 160 includes registrations of arbitrary group names 164 and path information 166 as additional information. For a group having “1,” as the group number 162, “Customers” is registered as the group name 164 and “\\MFP1\Customers” is registered as the path information 166. Further, the group folder information 160 may include only either one of the group name 164 and the path information 166.

The folder registering and creating unit 108 associates a folder represented by the path information 166 with each destination registered in the group folder information 160. The folder registering and creating unit 108 determines a presence or an absence of a folder designated by the path information 166. In case of an absence of such a folder, the folder registering and creating unit 108 automatically creates a folder designated by the path information 166. The path information 166 may include a device name, a folder name, and/or link information such as the URL. Alternatively, when a new group is registered with the group folder information 160, the registration accepting unit 104 activates the browser to enable the user to reference the data storage unit, and accepts a designation of a device and a folder or an instruction for creating a new folder. The destination registering unit 106 may register path information of the designated or newly created folder with the path information 166 of the group folder information 160.

As another embodiment, the folder registering and creating unit 108 may associate a folder having the group name 164 as a folder name with each group number 162 registered with the group folder information 160. The folder is stored in a prescribed directory of a prescribed data storage unit. The folder registering and creating unit 108 determines a presence or an absence of a folder having the keyword 146 as a folder name. In case of an absence of such a folder, the folder registering and creating unit 108 automatically creates a folder having the keyword 146 as the folder name. For example, the group name 164 registered with the group number 1 is “Customers”, and the folder registering and creating unit 108 associates a “Customers” folder 112b immediately under the root directory of the MFP 1 of FIG. 1 with the group number 1.

Further, the registration accepting unit 104 may accept an update of the information registered with the transmission destination information registering unit 102 as needed.

For example, the shared storage device 110 includes a plurality of folders such as the folder 112a and the folder 112b immediately under the root directory. The folder 112a has a folder name “AAA CORP.”. The folder 112b has a folder name “Customers”. The shared storage device 110 can store data forwarded from another PC 3 or the like over the network 5, image data of an original document scanned by a scanner (not illustrated), and/or data acquired from a web server via the Internet or the like. The interface unit 114 establishes a connection with the network 5, and carries out communication with the PC3 and the shared storage device 7.

The transmission destination accepting unit 116 accepts a designation of a transmission destination made by operating a one-touch dial key, entering a speed-dial number or designating a group. In the following, an example of processes carried out when accepting a designation of a transmission destination made by a one-touch dial key being operated is described. The folder specifying unit 118 accesses the transmission destination information registering unit 102, and acquires information of a folder associated with a destination (one-touch dial key) accepted by the transmission destination accepting unit 116, e.g. the keyword 146 of the one-touch dial destination information 140 of FIG. 3B. Then, the folder specifying unit 118 notifies the acquired information as folder information to the indicating unit 120. Alternatively, the folder specifying unit 118 acquires the destination name 143 of a destination corresponding to the one-touch dial key accepted by the transmission destination accepting unit 116 from the one-touch dial destination information 140 of FIG. 3A, and specifies a folder having the destination name 143 as a folder name. Then, the folder specifying unit 118 notifies the acquired destination name 143 as the folder information to the indicating unit 120.

Alternatively, the folder specifying unit 118 acquires the path information 148 of the destination corresponding to the one-touch dial key accepted by the transmission destination accepting unit 116 from the one-touch dial destination information 140 of FIG. 3C, and notifies the acquired path information 148 as folder information to the indicating unit 120.

The one-touch dial destination information 140 illustrated in FIGS. 3A-3C may include all of the key number 142, the destination name 143, the destination number 144, the keyword 146, and the path information 148. Each item is not necessarily required to be registered, and a folder may be specified according to the information registered for each destination. That is, when the keyword 146 is registered with the transmission destination accepted by the transmission destination accepting unit 116, the folder specifying unit 118 notifies the keyword 146 as the folder information to the indicating unit 120. Meanwhile, when the keyword 146 is unregistered and the path information 148 is registered, the folder specifying unit 118 notifies the path information 148 as the folder information to the indicating unit 120.

The indicating unit 120 receives the folder information from the folder specifying unit 118, and accesses the shared storage device 110 or accesses the PC 3 or the shared storage device 7 on the network 5 via the interface unit 114. Then, the indicating unit 120 searches a corresponding folder based on the folder information. The indicating unit 120 opens a found folder, and displays the folder on a display unit (not illustrated) of an operation panel. The indicating unit 120 displays information of data stored in the folder, for example, a list of file names and folder names. The indicating unit 120 is configured to display the data information stored in the folder on the display unit of the operation panel. However, the present invention is not limited to such an example. The data information stored in the folder may be displayed on another display device connected to the communication terminal device 100. In this case, the SMB protocol is used, for example.

The user refers to information stored in the folder indicated by the indicating unit 120, and selects a file. The attachment designation unit 122 designates the selected file as an attachment file. As another embodiment, the attachment designation unit 122 may automatically designate a file stored in a folder as an attachment file.

The attachment file storage unit 124 temporarily stores the file designated by the attachment designation unit 122. The transmission instruction accepting unit 126 accepts a transmission start instruction, for example, an operation of a start button (not illustrated). In response to the transmission start instruction accepted by the transmission instruction accepting unit 126, the transmission unit 128 attaches the attachment file stored in the attachment file storage unit 124, and carries out a transmission process to an electronic mail address of the destination accepted by the transmission destination accepting unit 116 via the interface unit 130. Alternatively, the transmission unit 12B carries out a transmission process to a fax number of the destination accepted by the transmission destination accepting unit 116 via the facsimile communication unit 132. The transmission unit 128 may include a function for creating and editing a main text and a cover page necessary for the transmission. The facsimile communication unit 132 includes a Modulator-Demodulator (MODEM) and a Network Control Unit (NCU), and carries out G3 or G4 facsimile communication according to an instruction from the transmission unit 128.

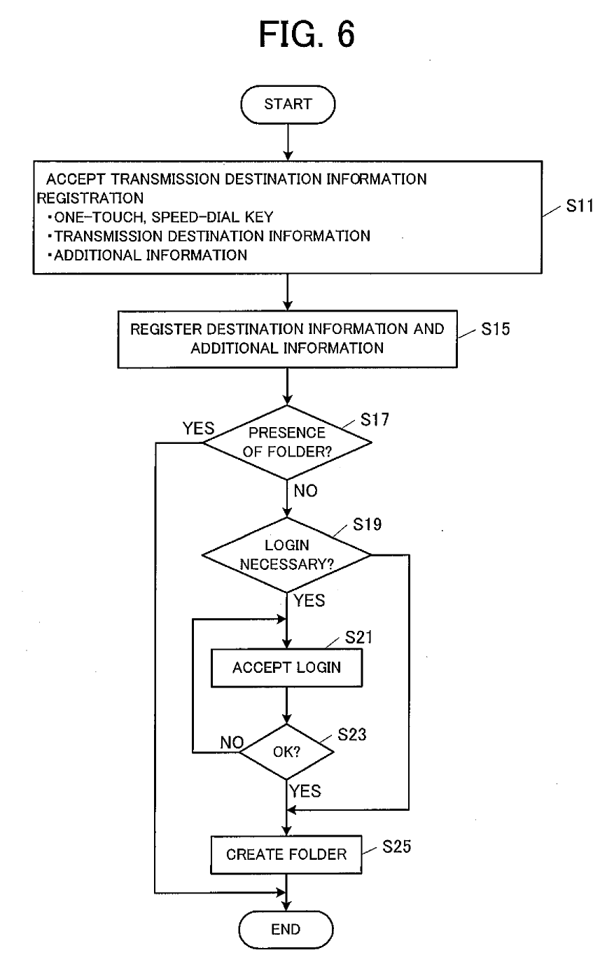

An operation carried out by the communication terminal device 100 is now described, First, an operation carried out by the communication terminal device 100 when registering a destination is described. FIG. 6 is a flowchart illustrating an example of an operation carried out by the communication terminal device 100 when registering a destination. In the following, an operation carried out by the communication terminal device 100 is described with reference to FIGS. 2-6.

First, the registration accepting unit 104 accepts a registration of a destination to be registered as a one-touch dial key or a speed-dial number (step S11). For example, in a registration accepting screen (not illustrated), the user selects a one-touch dial key, and enters destination information to be registered, for example, a destination name, a telephone number for facsimile, or an electronic mail address. The registration accepting unit 104 accepts the entered information. The registration accepting unit 104 can accept a keyword or path information of a folder to be used as a folder name of the folder to be associated with the destination information registered with the one-touch dial key.

The destination registering unit 106 registers the information accepted by the registration accepting unit 104 with the destination name 143 and the destination number 144 of the one-touch dial destination information 140 (FIG. 3A) stored in the transmission destination information registering unit 102. Furthermore, the destination registering unit 106 registers the keyword or the path information, which is used as the folder name of the folder to be associated with the destination information registered with the one-touch dial key, as the keyword 146 of the one-touch dial destination information 140 of FIG. 3B or the path information 148 of the one-touch dial destination information 140 of FIG. 3C. When the registration accepting unit 104 accepts a registration of a group, the destination registering unit 106 registers the accepted information with the group registration information 150 of FIG. 4.

The folder registering and creating unit 108 confirms a presence or an absence of a folder associated with the destination information registered at step S15 (step S17). For example, the folder registering and creating unit 108 can confirm a presence or an absence of a folder having a folder name including the destination name 143 of the one-touch dial destination information 140. Alternatively, the folder registering and creating unit 108 can confirm a presence or an absence of a folder having a folder name including the keyword 146 of the one-touch dial destination information 140 of FIG. 3B in the prescribed directory of the prescribed data storage unit. Alternatively, the folder registering and creating unit 108 can confirm a presence or an absence of a folder represented by the path information 148 of the one-touch dial destination information 140 of FIG. 3C. When the folder already exists (step S17: YES), the folder registering and creating unit 108 ends the processing.

In case of an absence of the folder (step S17: NO), a determination is carried out as to whether or not it is necessary to login to the data storage device that creates a folder (for example, the shared storage device 110 or the shared storage device 7) (step S19). When login is unnecessary (step S19: NO), the process proceeds onto step S25. When login is necessary (step S19: YES), the communication terminal device 100 accepts a user name and a password, and performs a login processing (step S21). When the user name and the password are successfully authenticated (step S23: YES), the folder registering and creating unit 108 creates a folder with a folder name including the destination name 143 or the keyword 146 of the one-touch dial destination information 140 registered at step S15 in the data storage unit. Alternatively, the folder registering and creating unit 108 creates a folder in the data storage unit according to the path information 148 of the one-touch dial destination information 140 (step S25).

Next, an example when registering a plurality of destinations as a group is described. At step S11, the registration accepting unit 104 accepts a destination to be registered with a group number, and the group number registered with each destination is stored in the group registration information 150 illustrated in FIG. 4. The registration accepting unit 104 presents a group information registering screen (not illustrated) to the user to urge the user to enter a keyword or path information designated for each group number.

When the registration accepting unit 104 accepts the keyword or the path information, the folder registering and creating unit 108 registers the group name 164 or the path information 166 with the group folder information 160 of FIG. 5 (step S15). The folder registering and creating unit 108 confirms a presence or an absence of a folder with a folder name including the group name 164 or the group number 162 registered with the group folder information 160 in a prescribed directory of a prescribed data storage unit (step S17). Alternatively, the folder registering and creating unit 108 confirms a presence or an absence of a folder represented by the path information 166 registered with the group folder information 160. The folder registering and creating unit 108 creates a folder according to the same procedure (steps S19 through S25) as when creating a folder for each destination as described above.

As described above, a folder can be registered in a manner that the folder can be specified based on the destination registered with the one-touch dial key or the speed-dial key. The folder registering and creating unit 108 can register the folder in a manner that the folder can be designated based on the registered group.

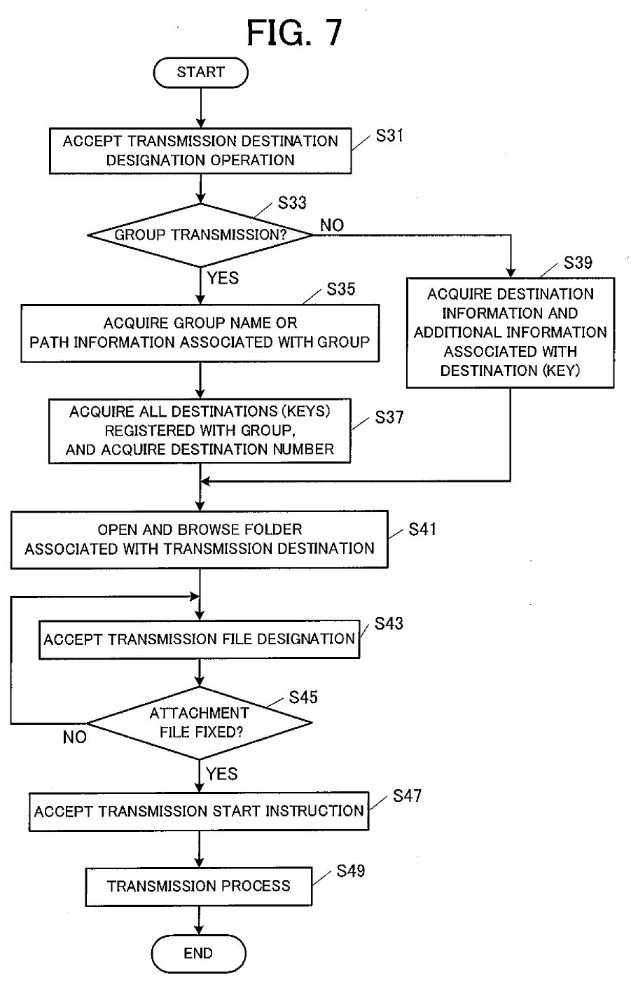

Next, an operation carried out by the communication terminal device 100 when transmitting data is described. FIG. 7 is a flowchart illustrating an example of an operation carried out by the communication terminal device 100 when transmitting data. The following description is with reference to FIGS. 2-5 and 7.

First, the user previously stores a transmission file in a prescribed folder of the shared storage device 7. For example, the user stores a transmission file in a folder with a folder name “AAA CORP.” immediately under the root directory of the communication terminal device 100 (MFP 1).

In the communication terminal device 100, the user designates a transmission destination by pressing a one-touch dial key, entering a speed-dial number, or entering a group number for group transmission. The transmission destination accepting unit 116 accepts the transmission destination designation operation (step S31). Broadcast transmission is described later.

In case of group transmission (step S33), the folder specifying unit 118 refers to the group folder information 160 (FIG. 5), and acquires the group name 164 or the path information 166 corresponding to the designated group (step S35). The folder specifying unit 118 notifies the folder name or the path information 166 including the acquired group name 164 to the indicating unit 120. The folder specifying unit 118 refers to the group registration information 150 (FIG. 4) stored in the transmission destination information registering unit 102, and acquires all one-touch dial keys and speed-dial keys registered with the group number accepted at step S31 (step S37).

The folder specifying unit 118 refers to the one-touch dial destination information 140 of FIG. 3A and the speed-dial destination information, and acquires the destination number registered with the acquired one-touch dial key and the speed-dial key from the one-touch dial destination information 140 and the speed-dial destination information. The destination number acquired in such a manner is provided as a transmission destination. Further, the process of step S37 may be carried out by the transmission destination accepting unit 116.

Meanwhile, when it is not group transmission (step S33: NO), the folder specifying unit 118 refers to the speed-dial destination information or the one-touch dial destination information 140 stored in the transmission destination information registering unit 102, and acquires a destination name, a keyword or path information registered with the speed-dial number or the one-touch dial key accepted at step S31 (step S39). The acquired destination number is provided as a transmission destination. Further, the destination number may be acquired by the transmission destination accepting unit 116.

The folder specifying unit 118 notifies the folder name or the path information including the acquired destination name, the destination number or the keyword to the indicating unit 120. The indicating unit 120 opens a folder and displays the folder on the display unit according to the folder name or the path information notified from the folder specifying unit 118 (step S41). The user can browse the information included in the folder displayed on the display unit.

The above-described operation is described with reference to an example in which the user presses the one-touch dial key “01” and designates “AAA CORP.” as a destination. The transmission destination accepting unit 116 accepts pressing of the one-touch dial key “01” (step S31). Since it is not the group transmission (step S33: NO), the folder specifying unit 118 accesses the one-touch dial destination information 140 stored in the transmission destination information registering unit 102, and acquires the destination name 143 “AAA CORP.”, the destination number 144 “03-xxxx-1000”, the keyword 146 “AAA”, or the path information 148 “\\MFP1\AAA” of the one-touch dial key “01” (step S39).

The folder specifying unit 118 notifies the folder name including the destination name 143 “AAA CORP.” or the keyword 146 “AAA”, or the path information 148 “\\MFP1\AAA” to the indicating unit 120. The indicating unit 120 searches in the data storage unit, a folder having the notified folder name or a folder represented by the notified path information. The indicating unit 120 searches the folder including the destination name 143 “AAA CORP.” in the communication terminal device 100, and opens the folder. Then, the file information included in the folder is displayed on the display unit (step S41). As described above, the folder “\\MFP1\AAA CORP” associated with the destination “AAA CORP.” designated by the one-touch dial key “01” is specified and opened. Accordingly, the user can browse the file information included in the folder. That is, just by pressing the one-touch dial key and designating a destination, without requiring the user to search the folder, the user can browse the file information included in the folder that has been opened automatically.

The user selects an attachment file from files included in the browsed folder. The attachment designation unit 122 accepts the selected file (step S43). Further, the attachment designation unit 122 can be previously set to automatically accept all files included in the folder specified at step S41 as attachment files. Further, in such a case, after the files are transmitted, the transmitted files are preferably deleted automatically from the folder. Alternatively, after the files are transmitted, the transmitted files may be moved to a prescribed folder created for storing the transmitted files.

The accepted files are temporarily stored in the attachment file storage unit 124. Then, a determination is carried out as to whether or not all of the attachment files have been selected and fixed (step S45). When the selection is fixed (step S45: YES), the transmission instruction accepting unit 126 accepts a transmission instruction (step S47), and notifies to the transmission unit 128. The transmission unit 128 transmits the attachment files stored in the attachment file storage unit 124 to the destination having the destination number acquired at step S37 or S39 by the folder specifying unit 118 (step S49). The facsimile communication unit 132 carries out a transmission process to a telephone number for facsimile “03-xxxx-1000” of AAA CORP. registered with the one-touch dial key “01”. When the selection has not been fixed at step S45 (step S45: NO), the process returns to step S43 and a further designation of an attachment file can be accepted.

Next, an example when group transmission is designated is described. In this example, the user stores a file, which is to be transmitted to destinations registered with the group number “01”, in the customer folder 112b (path is \\MFP1\customers) of the shared storage device 110.

At step S31 of FIG. 7, when the user designates the group number “1” for the group transmission, the transmission destination accepting unit 116 accepts the group number “1” (step S31). Since it is the group transmission (step S33: YES), the folder specifying unit 118 accesses the group folder information 160 (FIG. 5) to acquire the path information 166 “\\MFP1\customers” of the group number “1”, and notifies the acquired path information 166 to the indicating unit 120 (step S35). The folder specifying unit 118 refers to the group registration information 150 (FIG. 4), and acquires all of the speed-dial keys and the one-touch dial keys registered with the group number “1” (step S37). In one embodiment, the one-touch dial keys “01” and “02” are registered with the group number “1”.

The folder specifying unit 118 accesses the one-touch dial destination information 140 (FIG. 3A), and acquires destination numbers 144 “03-xxxx-1000” and “045-xxx-9876” of the one-touch dial keys “01” and “02” as transmission destinations (step S37). The indicating unit 120 searches a folder represented by the path information 148 notified at step S35, opens the folder, and displays the file information included in the opened folder on the display unit (step S41). As described above, the user can browse the file information included in the folder “\\MFP1\customers” storing the file to be transmitted to the destinations designated by the group number “01”. The user can select a transmission file from the opened folder.

After the attachment designation unit 122 accepts a designation of all attachment files (step S43, and step S45: YES), the transmission instruction accepting unit 126 accepts a transmission start instruction (step S47). The transmission unit 128 attaches the attachment files designated at step S43, and carries out a transmission process to the two destination numbers 144 acquired at step S37 via the facsimile communication unit 132 (step S49).

Next, broadcast transmission is described. When a plurality of destinations are designated as the transmission destination at step S31, destination information and additional information are acquired for each group, each one-touch dial key and each speed-dial number accepted by the transmission destination accepting unit 116 (steps S35 through S37). The folder specifying unit 118 specifies a folder according to the destination information and the additional information, and notifies the specified folder to the indicating unit 120. The indicating unit 120 opens the folder (step S41).

When a plurality of folders are specified, the indicating unit 120 notifies the user that there are a plurality of folders associated with a plurality of transmission destinations designated as broadcast destinations, to enable the user to select from which folder to browse. Alternatively, the indicating unit 120 may simultaneously open and indicate all folders, or sequentially open and indicate the folders one-by-one. The order may be a prescribed order designated previously, such as an order in which the folders have been designated, an order of destination names, an order of registered key numbers, an order of destination numbers, an order of keywords, or an order of path names. Even when opening the folders simultaneously, by slightly displacing windows with respect to one another or by displaying the windows arranged next to one another, the user can recognize that there are a plurality of folders.

When the broadcast transmission is designated for a group and an individual destination, and the designated destination is included in the designated group, the folder associated with the group may be preferentially indicated.

As described above, a folder may be registered by being associated with the destination information. Therefore, by storing transmission data in such a folder, just by designating a destination at transmission, the user can refer to the folder stored in a data storage location. As a result, time and effort required for finding a folder when designating a transmission file can be omitted, and operability improves.

An embodiment of the present invention has been described with reference to the drawings. However, the above-described embodiment is just one of the examples of the present invention, and various other modifications may be adopted.

For example, the communication terminal device 100 may also include a deleting unit for automatically deleting files, which have been transmitted by the transmission unit 128, from a folder where the files have been stored. Alternatively, the files, which have been transmitted by the transmission unit 128, may be moved to a prescribed folder storing transmitted files. According to this constitution, since transmitted data can be deleted automatically from the folder, it is possible to prevent a large number of transmitted files from being accumulated in the folder.

As another embodiment, when a destination registered with a group is designated as a transmission destination by a one-touch dial key or a speed-dial number, it is possible to enable a user to refer to a folder associated with the group to which the designated destination belongs.

For example, when the transmission destination accepting unit 116 accepts a one-touch dial key “04”, the folder specifying unit 118 accesses the one-touch dial destination information 140 stored in the transmission destination information registering unit 102, and acquires a destination name 143 “BBB LTD.” and a destination number 144 “045-xxx-9876” of the one-touch dial key “04”. Then, the folder specifying unit 118 notifies the destination name 243 “BBB LTD.” to the indicating unit 120. The folder specifying unit 118 refers to the group registration information 150, and acquires group numbers “2” and “4” registered with the one-touch dial key “04”. Then, the folder specifying unit 118 notifies path information “\\shared2\headquarter” and “\\PC3\sales” of the folders associated with the group numbers “2” and “4” to the indicating unit 120. The indicating unit 120 opens a folder with a folder name including the destination name 143 “BBB LTD.” and a folder represented by the notified path information, and indicates file information to the user.

As described above, when destinations are registered as a group, if it is possible to refer to a folder associated with the group to which a destination designated as a transmission destination is registered, it is convenient to retransmit files, which have been previously transmitted to the group, to only some of the destinations of the group.

While the present invention has been described with respect to exemplary embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A communication terminal device comprising:
a destination information registering unit which registers destination information to be a transmission destination when transmitting transmission data;
a folder registering unit which registers a folder by associating the folder with the destination information registered in the destination information registering unit in a manner that the folder can be specified based on the destination information;
a destination accepting unit which accepts a designation of destination information to be a transmission destination of transmission data from the destination information registered in the destination information registering unit;
a folder specifying unit which specifies a folder corresponding to the destination information accepted by the destination accepting unit;
a data information acquiring unit which acquires data information of the folder specified by the folder specifying unit;
an indicating unit which indicates the data information acquired by the data information acquiring unit;
a transmission data accepting unit which accepts a designation of the transmission data by using the data information indicated by the indicating unit; and
a transmission unit which transmits the transmission data accepted by the transmission data accepting unit to the transmission destination.

2. The communication terminal device according to claim 1, wherein the destination information registering unit includes additional information into the destination information,
the folder registering unit registers the folder by associating the folder with the additional information of the destination information in a manner that the folder can be designated based on the additional information, and
the folder specifying unit acquires the additional information of the destination information accepted by the destination accepting unit from the destination information registering unit, and specifies the folder based on the additional information.

3. The communication terminal device according to claim 1, wherein when newly registering destination information in the destination information registering unit, the folder registering unit automatically creates a new folder in a data storage unit of the communication terminal device or a data storage unit of a remote storage device, which can be referenced by the communication terminal device via a network, by associating the new folder with the destination information, and registers the new folder by associating with the newly registered destination information.

4. The communication terminal device according to claim 3, wherein when automatically creating the new folder, the folder registering unit generates a folder name based on the destination information and assigns the generated folder name to the new folder.

5. The communication terminal device according to claim 3, wherein the folder registering unit determines a presence or an absence of the folder, which can be specified based on the newly registered destination information, in the data storage unit, and in case of the presence of the folder that can be specified, the folder registering unit registers the existing folder that can be specified by associating the folder with the destination information without creating a new folder.

6. The communication terminal device according to claim 1, wherein the destination information registering unit can register a plurality of destination information as a group, and the folder registering unit can register a folder by associating the folder with the group in a manner that the folder can be specified based on the group.

7. The communication terminal device according to claim 1, wherein when the destination accepting unit accepts a plurality of destination information as the transmission destination, in case of a presence of a plurality of folders corresponding to the plurality of the destination information, the data information acquiring unit acquires data information of the plurality of the folders, and the indicating unit indicates each of the plurality of the data information acquired by the data information acquiring unit.

8. The communication terminal device according to claim 1, further comprising a deleting unit, wherein after the transmission unit transmits the transmission data, the deleting unit deletes the transmitted transmission data from the folder.

9. The communication terminal device according to claim 1, further comprising a moving unit, wherein after the transmission unit transmits the transmission data, the moving unit moves the transmitted transmission data from the folder to another folder.

10. A communication terminal device comprising:
means for registering destination information to be a transmission destination when transmitting transmission data;
means for registering a folder by associating the folder with the registered destination information in a manner that the folder can be specified based on the registered destination information;
means for accepting a designation of destination information to be a transmission destination of transmission data from the registered destination information;
means for specifying a folder corresponding to the accepted destination information;
means for acquiring data information of the specified folder;
means for indicating the acquired data information;
means for accepting a designation of transmission data by using the indicated data information; and
means for transmitting the accepted transmission data to the transmission destination.

11. The communication terminal device according to claim 10, further comprising:
means for including additional information in the destination information;
means for registering a folder by associating the folder with the additional information of the destination information in a manner that the folder can be specified based on the additional information; and
means for acquiring the additional information of the accepted destination information and specifying the folder based on the additional information.

12. The communication terminal device according to claim 10, further comprising:
means for automatically creating a new folder in a data storage unit of the communication terminal device or a data storage unit of a remote storage device, which can be referenced by the communication terminal device via a network, when newly registering destination information, by associating the new folder with the destination information; and
means for registering the new folder by associating the new folder with the newly registered destination information.

13. The communication terminal device according to claim 12, further comprising means for generating a folder name based on the destination information and assigning the generated folder name to the new folder when automatically creating the new folder.

14. The communication terminal device according to claim 12, further comprising:
means for determining a presence or an absence of the folder, which can be specified based on the newly registered destination information, in the data storage unit; and
means for registering, wherein in case of the presence of the folder that can be specified, without creating a new folder, the means for registering registers the existing folder that can be specified by associating the existing folder with the destination information.

15. The communication terminal device according to claim 10, further comprising:
means for registering a plurality of destination information as a group; and
means for registering the folder by associating the folder with the group in a manner that the folder can be specified based on the group.

16. The communication terminal device according to claim 10, further comprising:
means for acquiring data information of a plurality of folders when accepting a plurality of destination information as the transmission destination and in case there are a plurality of folders corresponding to the plurality of the destination information, and
means for indicating each of the acquired plurality of the data information.

17. The communication terminal device according to claim 10, further comprising means for deleting, after the means for transmitting transmits the transmission data, the transmitted transmission data from the folder.

18. The communication terminal device according to claim 10, further comprising means for moving, after the means for transmitting transmits the transmission data, the transmitted transmission data to another folder from the folder.

19. A communication method comprising the steps of:
registering destination information to be a transmission destination when transmitting transmission data;
registering a folder by associating the folder with the registered destination information in a manner that the folder can be specified based on the registered destination information;
accepting a designation of destination information to be a transmission destination of transmission data from the registered destination information;
specifying a folder corresponding to the accepted destination information;
acquiring data information of the specified folder;
indicating the acquired data information;
accepting a designation of the transmission data by using the indicated data information; and
transmitting the accepted transmission data to the transmission destination.

20. The communication method according to claim 19, further comprising the steps of:
including additional information in the destination information;
registering a folder by associating the folder with the additional information of the destination information in a manner that the folder can be specified based on the additional information; and
acquiring the additional information of the accepted destination information and specifying the folder based on the acquired additional information.
